(19) United States
(12) Patent Application Publication
(10) Pub. No.: US 2020/0324877 A1
(43) Pub. Date: Oct. 15, 2020

(54) METHOD AND SYSTEM FOR FEATHERING A PROPELLER

(71) Applicant: PRATT & WHITNEY CANADA CORP., Longueuil (CA)

(72) Inventors: Jasraj CHAHAL, Lasalle (CA); Carmine LISIO, Laval (CA); Darragh MCGRATH, Montreal (CA); Michael YOUSSEF, Mississauga (CA); Giancarlo ZINGARO, Pointe-Claire (CA)

(21) Appl. No.: 16/378,698

(22) Filed: Apr. 9, 2019

(51) Int. Cl. B64C 11/32; B64C 11/34

(52) U.S. Cl. CPC B64C 11/325; B64C 11/34

(57) ABSTRACT

Methods and systems for feathering a propeller are described herein. A solenoid is configured to cause a propeller to feather when the solenoid is energized. An electronic controller is connected to the solenoid through a first electrical connection for energizing the solenoid to feather the propeller. A secondary mechanism is connected to the solenoid through a second electrical connection for energizing the solenoid to feather the propeller. The second electrical connection is independent from the first electrical connection.

### TECHNICAL FIELD

The present disclosure relates generally to aircraft propeller control, and more particularly to feathering a propeller.

### BACKGROUND OF THE ART

For propeller driven aircraft, a control system may adjust the blade angle of the propeller blades to a feather position to reduce forward drag on the aircraft. For example, a propeller electronic controller may control a feather solenoid and a protection solenoid, which both have the ability to drive the propeller blades to the feather position. An additional solenoid connected to a lever in the cockpit of the aircraft is typically provided for emergency purposes to feather the propeller. However, this additional solenoid adds weight and additional cost to the overall propeller system.

As such, there is a need for improvement.

### SUMMARY

In one aspect, there is provided a system comprising a solenoid configured to cause a propeller to feather when the solenoid is energized, an electronic controller connected to the solenoid through a first electrical connection for energizing the solenoid to feather the propeller, and a mechanism connected to the solenoid through a second electrical connection for energizing the solenoid to feather the propeller, the second electrical connection being independent from the first electrical connection.

In another aspect, there is provided a method for feathering a propeller. The method comprises energizing a solenoid to feather the propeller when a first request to energize the solenoid is received from an electronic controller through a first electrical connection with the solenoid and energizing the solenoid to feather the propeller when a second request to energize the solenoid is received from a secondary mechanism through a second electrical connection with the solenoid, the second electrical connection being independent from the first electrical connection.

In another aspect, there is provided a method comprising connecting a solenoid to an electronic controller through a first electrical connection, the solenoid is configured to cause a propeller to feather when the solenoid is energized by the electronic controller through the first electrical connection, and connecting the solenoid to a secondary mechanism through a second electrical connection, the solenoid is configured to cause the propeller to feather when the solenoid is energized by the secondary mechanism through the second electrical connection, the second electrical connection being independent from the first electrical connection.

### BRIEF DESCRIPTION OF THE DRAWINGS

Reference is now made to the accompanying figures in which:

FIG. 1 is a schematic of an example gas turbine engine coupled to a propeller, in accordance with one or more embodiments;

FIG. 2A is a schematic diagram illustrating a system for feathering a propeller, in accordance with one or more embodiments;

FIG. 2B is a schematic diagram illustrating examples of switches of the system for feathering a propeller, in accordance with one or more embodiments;

FIG. 2C is a schematic diagram illustrating examples of a dual coil solenoid and a dual channel electronic controller, in accordance with one or more embodiments;

FIG. 3A is a flowchart of a method for feathering a propeller, in accordance with one or more embodiments;

FIG. 3B is a flowchart of another method, in accordance with one or more embodiments; and

FIG. 4 is a block diagram of an example computing device, in accordance with one or more embodiments.

It will be noted that throughout the appended drawings, like features are identified by like reference numerals.

### DETAILED DESCRIPTION

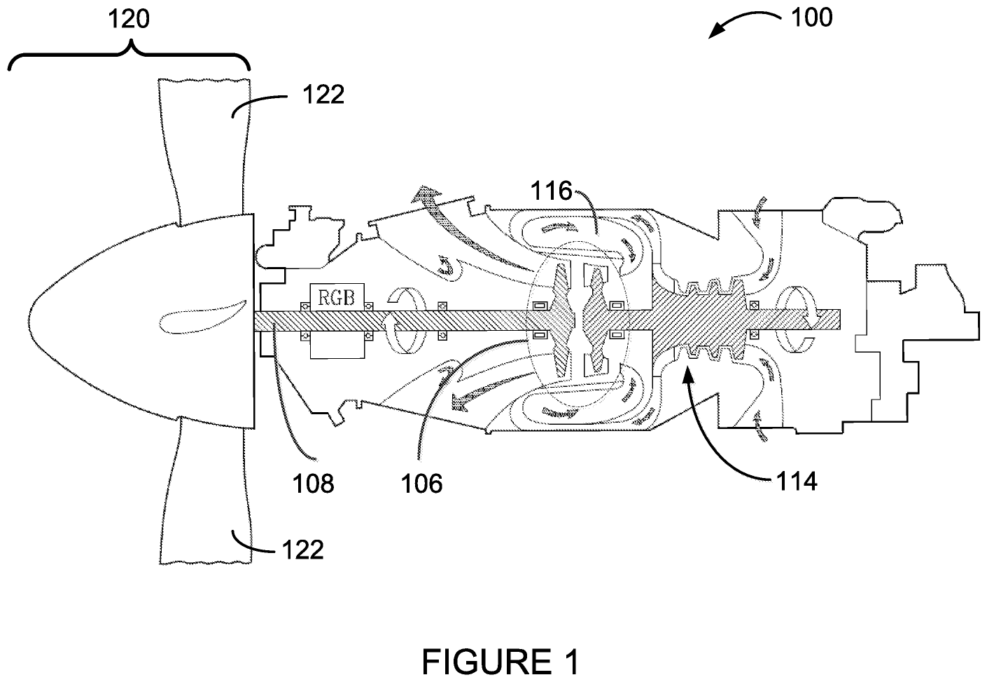

FIG. 1 illustrates an aircraft engine 100 for an aircraft of a type preferably provided for use in subsonic flight. The engine 100 generally comprises in serial flow communication a propeller 120 attached to a shaft 108 and through which ambient air is propelled, a compressor section 114 for pressurizing the air, a combustor 116 in which the compressed air is mixed with fuel and ignited for generating an annular stream of hot combustion gases, and a turbine section 106 for extracting energy from the combustion gases. The propeller 120 converts rotary motion from the shaft 108 of the engine 100 to provide propulsive force for the aircraft, also known as thrust. The propeller 120 comprises two or more propeller blades 122. The blade angle of the propeller blades 122 may be adjusted to vary the thrust. The blade angle may be referred to as a beta angle, an angle of attack or a blade pitch. The engine 100 may be implemented to comprise a single or multi-spool gas turbine engine, where the turbine section 106 is connected to the propeller 120 typically through a reduction gearbox (RGB). It should be understood that while the engine 100 is a turboprop engine, the methods and systems described herein may be applicable to any other type of gas turbine engine, such as a turbofan, turboshaft, or any other suitable aircraft engine.

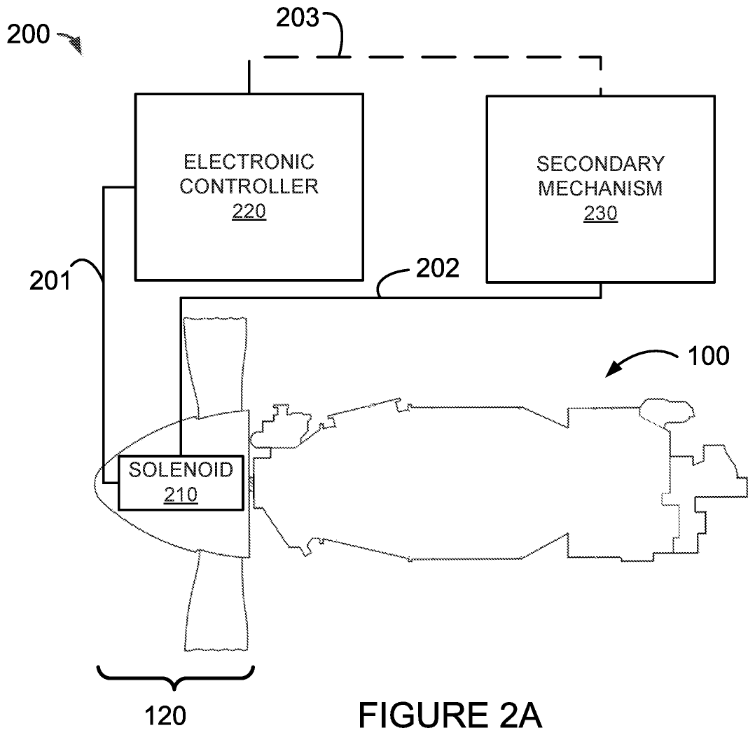

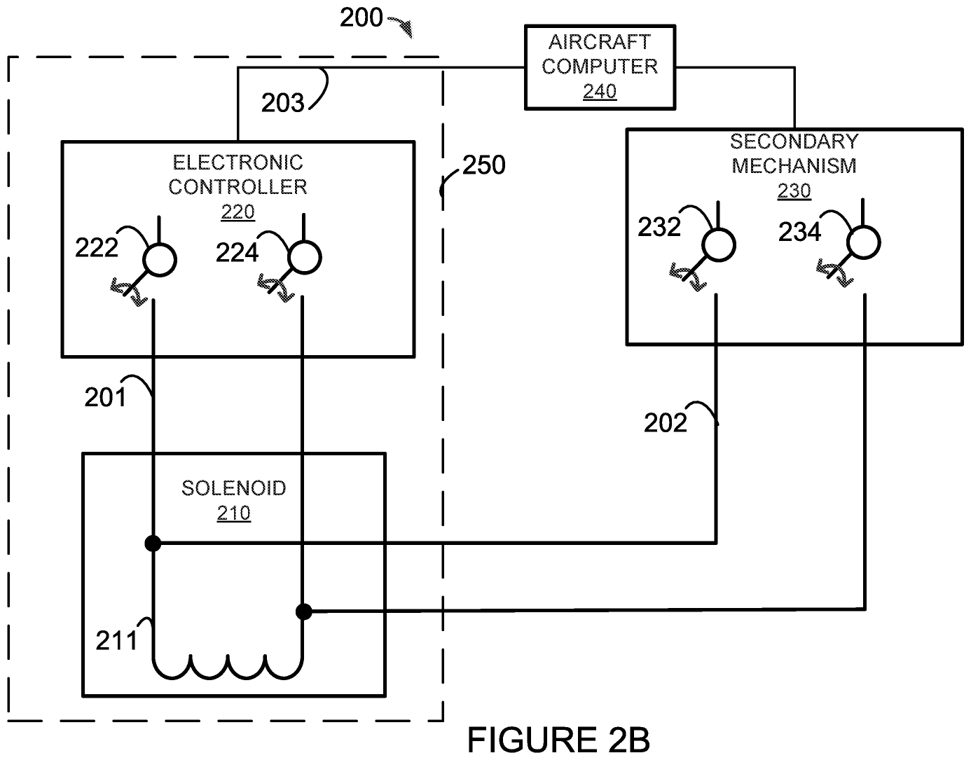

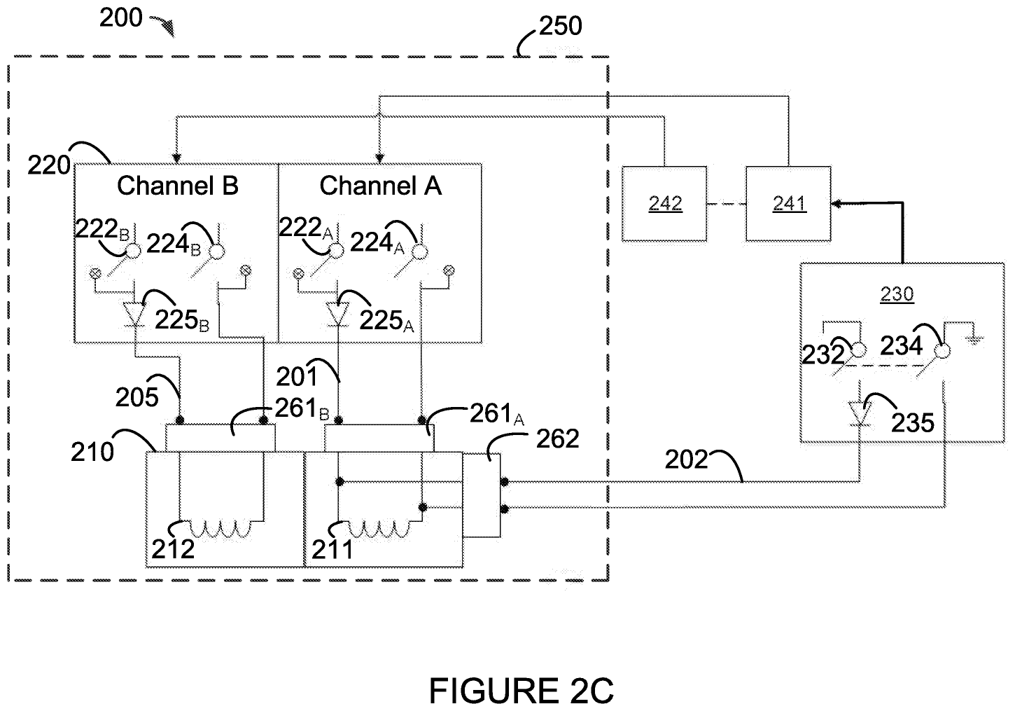

With reference to FIG. 2A, there is illustrated a system 200 for feathering a propeller, such as the propeller 120 of FIG. 1, in accordance with one or more embodiment. The system 200 comprises a solenoid 210 configured to cause the propeller 120 to feather when the solenoid 210 is energized. The system 200 comprises an electronic controller 220 connected to the solenoid 210 through a first electrical connection 201 for energizing the solenoid 210 to feather the propeller 120. The system 200 comprises a secondary mechanism 230 connected to the solenoid 210 through a second electrical connection 202 for energizing the solenoid 210 to feather the propeller 120. The electronic controller 220 and the secondary mechanism 230 are independently operable of each other for energizing the solenoid 210 to feather the propeller 120. The first electrical connection 201 and the second electrical connection 202 are separate connections and are independent of each other. Reference to “feathering” the propeller 120 or adjusting the blade angle to “feather” the propeller 120 refers to directing the blades of the propeller 120 to the feather position. In the feather position, the propeller blades are positioned at an angle substantially parallel to the airflow on the propeller 120 in order to reduce forward drag on the aircraft. While the engine 100 and propeller 120 are illustrated as being part of the system 200, it should be understood that this is for illustrative purposes only and that the system 200, in some embodiments, does not comprise the engine 100 and propeller 120.

The solenoid 210 is an electro-hydraulic actuator used to adjust the blade angle of the propeller 120. The solenoid 210 is considered energized when at least one coil of the solenoid 210 is energized. When the coil of the solenoid 210 is energized, a solenoid valve is actuated to adjust a supply of hydraulic fluid to the propeller 120 to drive the blade angle of the propeller 120 towards the feather position. The solenoid 210 when energized may hydraulically by-pass a pitch modulation actuator, for example, such as a pitch change unit, used for fine adjustment of propeller blade angle over the full range of the propeller blade pitch. In some embodiments, the solenoid 210 is a feather solenoid, which may be used for a routine feather or an autofeather operation. In some embodiments, the solenoid 210 is a protection solenoid, which may be used when propeller overspeed is detected or if the propeller blade angle is below a minimum allowable in-flight blade angle.

It should be appreciated that by connecting the secondary mechanism 230 to the same solenoid 210 that the electronic controller 220 is connected thereto, that a dedicated emergency solenoid conventionally connected to the secondary mechanism 230 may be eliminated and that the overall weight and/or cost of the propeller system may be reduced.

The electronic controller 220 may be any suitable electronic controller configured to energize the solenoid 210 for feathering the propeller 120. For example, the electronic controller 220 may close at least one switch to energize the solenoid 210 via the first electrical connection 201. The electronic controller 220 may energize the solenoid 210 in response to detecting that the propeller 120 should be driven to the feather position. For example, the electronic controller 220 may command the propeller blade angle to the feather position for a routine feather preceding a shutdown of the engine 100 on-ground. The electronic controller 220 may command the propeller blade angle to the feather position for an autofeather, for example, when the engine 100 has failed during takeoff. The electronic controller 220 may command the propeller blade angle to the feather position when the rotational speed of the propeller exceeds a threshold to protect the propeller 120 from overspeed. The electronic controller 220 may command the propeller blade angle to the feather position when the blade angle of the propeller 120 is below the minimum in-flight propeller blade angle. In some embodiments, the electronic controller 220 energizes the solenoid 210 in response to receiving a feather command from an engine or aircraft computer, for example, used to detect when the propeller 120 should be driven to the feather position. In some embodiments, the electronic controller 220 is a propeller electronic controller.

In some embodiments, the secondary mechanism 230 is an emergency mechanism which may be actuated for an emergency feather of the propeller 120. The secondary mechanism 230 may be any suitable mechanism configured to energize the solenoid 210 for feathering the propeller 120. For example, the secondary mechanism 230 may close at least one switch to energize the solenoid 210 via the second electrical connection 202. The secondary mechanism 230 may comprise a non-electronic controller. For example, the secondary mechanism 230 may be a mechanism that is mechanical, pneumatic, hydraulic or a combination thereof. The secondary mechanism 230 may comprise a mechanical lever in the aircraft that when actuated by a flight crew member (e.g., the pilot or other personnel) causes the solenoid 210 to be energized. For example, the mechanical lever may be operable to close at least one switch to energize the solenoid 210 when the mechanical level is actuated. The mechanical lever may be known as a fire handle. The secondary mechanism 230 may comprise an electronic controller. For example, a second electronic controller (i.e., separate from the first electronic controller 220) may be operable to close a least one switch to energize the solenoid 210 when an actuator (e.g., a push-button, an illuminated button, a switch, a dial, a knob, any other suitable interface, or the like) connected to the second electronic controller is actuated. The second electronic controller may be an aircraft computer.

In some embodiments, the secondary mechanism 230 is connected to the electronic controller 220 via a connection 203 and is configured to provide the electronic controller 210 an indication when the secondary mechanism 230 is actuated. In some embodiments, the electronic controller 220 is configured to disable energizing of the solenoid 210 with the electronic controller 220 in response to receiving the indication. For example, the electronic controller 220 may disable energizing of the solenoid 210 for autofeather, routine feather, propeller overspeed protection, minimum in-flight propeller blade angle, and/or the like. In some embodiments, the electronic controller 220 is configured to disable fault detection of at least one switch used to energize the solenoid 210 through the first electrical connection 201 in response to receiving the indication. The fault detection of the electronic controller 220 may assess if the electronic controller 220 commanded the energizing of the solenoid 210. If the electronic controller 220 did not command the energizing of the solenoid 210 and solenoid 210 is energized, the electronic controller 220 may detect a fault of at least one switch. When a fault is detected, the fault may be outputted to a display device to indicate the fault. The secondary mechanism 230 may be connected directly or indirectly to the electronic controller 210 for providing the indication. The indication may be provided as an analog or digital signal.

With reference to FIG. 2B, in some embodiments, the electronic controller 220 and the secondary mechanism 230 each comprise two switches. In some embodiments, the electronic controller 220 is configured to operate (i.e., open and close) a high side switch 222 and a low side switch 224. When both the high side switch 222 and the low side switch 224 are closed, a coil 211 of the solenoid 210 is energized. The high side switch 222 when closed, provides a power source (e.g., a 28 V source, or any other suitable voltage) to the first electrical connection 201 and the low side switch 224 when closed, provides a ground connection to the first electrical connection 201. If either one (or both) of the switches 222, 224 are open, then the solenoid 210 would not be energized via the first electrical connection 201. One of the switches 222, 224 may by default be kept in the closed position and the electronic controller 220 may be configured to operate the other one of the switches 222, 224 to energize the solenoid 210. Alternatively, in some embodiments, the electronic controller 220 comprises one high side switch or one low side switch operable for energizing the solenoid 210.

In some embodiments, the secondary mechanism 230 is configured to close a high side switch 232 and a low side switch 234 when actuated. When both the high side 232 switch and the low side switch 234 are closed, the coil 211 of the solenoid 210 is energized. As shown, the secondary mechanism 230 is connected to the same solenoid coil 211 that the electronic controller 220 is connected thereto. The high side switch 232 when closed, provides a power source (e.g., a 28 V source, or any other suitable voltage) to the second electrical connection 202 and the low side switch 234 when closed, provides a ground connection to the second electrical connection 202. If either one (or both) of the switches 232, 234 are open, then the coil 211 of the solenoid 210 would not be energized via the second electrical connection 202. If either one (or both) of the switches 222, 224 are open, then the coil 211 of the solenoid 210 may be energized via the second electrical connection 202 by closing switches 232 and 234. One of the switches 232, 234 may by default be kept in the closed position and the secondary mechanism 230 may be configured to close the other one of the switches 222, 224 when actuated. Alternatively, in some embodiments, the secondary mechanism 230 comprises one high side switch or one low side switch operable for energizing the solenoid 210. In some embodiments, the switches 232, 234 can be operated simultaneously by a single control (also known as a “gang switch”) to energize the solenoid 210.

In some embodiments, such as shown in FIG. 2B, the secondary mechanism 230 is connected to the electronic controller 220 via an aircraft computer 240. The aircraft computer 240 may monitor the secondary mechanism 230 to detect when the secondary mechanism 230 is actuated. For instance, the aircraft computer 240 may monitor at least one of the switches 232, 234 to detect when the mechanism 230 is actuated. Alternatively, the secondary mechanism 230 may provide an indication to the aircraft computer 240 when actuated. When the secondary mechanism 230 is actuated, the indication that the secondary mechanism 230 is actuated may be provided to the electronic controller 220 from the aircraft computer 240. In some embodiments, the secondary mechanism 230 comprises the aircraft computer 240.

The reference numeral 250 illustrates the electronic controller 220 and the solenoid 210 position in a zone subject to a possible fire (hereinafter the “fire zone”). As an emergency feather may be required when there is a fire, the hardware and/or components relating to the emergency feather that is positioned in the fire zone 250 may be made of fireproof or fire-resistant materials. Accordingly, in some embodiments, the second electrical connection 202 is a fireproof or fire-resistant connection. In some embodiments, the connection 203 between the aircraft computer 240 and the electronic controller 220 is a fireproof or fire-resistant connection.

With reference to FIG. 2C, in some embodiments, the electronic controller 220 comprises two or more channels, such as channels A and B. The channels A, B are redundant channels and one of the channels (e.g., channel A) is selected as being active, while the other channel remains in standby (e.g., channel B). When a channel is active, that channel may be used to energize the solenoid 210 to feather the propeller 120, and when a channel is in standby, that channel is not used to energize the solenoid 210 to feather the propeller 120. When a channel is in standby, the channel is functional and able to take over control when needed. If it is determined that the presently active channel is faulty or inoperative, the presently active channel may be inactivated and a channel in standby is activated. Similarly, if, during operation, an input to a presently active channel is erroneous or inexistent, the presently active channel may be inactivated and one of the channels in standby is activated.

As shown in FIG. 2C, each channel A, B of the electronic controller 220 comprises a high side switch 222_{A} or 222_{B} and a low side switch 224_{A} or 224_{B}. Each channel A, B operates the low side switch 222_{A} or 222_{B} and the high side switch 224_{A} or 224_{B} in a similar manner as that described in relation to the electronic controller 220 of FIG. 2B. When both the high side switch 222_{A} and the low side switch 224_{A} of channel A are closed, a first coil 211 of the solenoid 210 is energized via the first electrical connection 201 to energize the solenoid 210. When both the high side switch 222_{B} and the low side switch 224_{B} of channel B are closed, a second coil 212 of the solenoid 210 is energized via a separate electrical connection 205 to energize the solenoid 210. Alternatively, is some embodiments, each channel A, B comprises one high side switch or one low side switch operable for energizing the solenoid 210.

In some embodiments, as illustrated in FIG. 2C, the solenoid 210 is configured such that only one of the two coils 211, 212 needs to be energized to feather the propeller 120. In some embodiments, the second electrical connection 202 connects the secondary mechanism 230 to one of the two coils 211, 212 of the solenoid 210, which is also connected to one of the channels of the electronic controller 220. In some embodiments, the solenoid 210 comprises a first connector 261_{A} and a second connector 262. The first connector 261_{A} connects channel A of the electronic controller 220 to the first coil 211 and the second connector 262 connects the secondary mechanism 230 to the first coil 211. Another connector 261_{B} may be used to connect channel B of the electronic controller 220 to the second coil 212. While the secondary mechanism 230 is shown connected to the first coil 211, in other embodiments, the secondary mechanism 230 may be connected to the second coil 212. Alternatively, in some embodiments, the mechanism 230 is connected to both coils 211, 212 of the solenoid 210.

As shown in FIG. 2C, in some embodiments, the secondary mechanism 230 is connected to each one of the two channels A, B, to provide the indication that the secondary mechanism 230 is actuated. A first aircraft computer 241 may obtain the indication that the secondary mechanism 230 is actuated. The indication that the secondary mechanism 230 is actuated may be provided to one of the channels (e.g., channel A) of the electronic controller 220 from the first aircraft computer 241. In some embodiments, the indication that the secondary mechanism 230 is actuated may be provided from the first aircraft computer 241 to a second aircraft computer 242, which provides the indication to the other channel (e.g., channel B) of the electronic controller 220. In some embodiments, the second aircraft computer 242 may obtain the indication from the secondary mechanism 230 and provide the indication to one of the channels (e.g., channel B). Alternatively, in some embodiments, a single aircraft computer may be used to provide the indication to both channels A, B.

A diode 225_{A} or 225₈ may be positioned between the high side switch 222_{A} or 222_{B} of each channel A, B and the solenoid 210 for electrical current backflow protection. The diode 225_{A} may prevent electrical power from the secondary mechanism 230 from damaging the electronic controller 220. Similarly, a diode 235 may be used for electrical current backflow protection to prevent electrical power from the electronic controller 220 from damaging the secondary mechanism 230. Other suitable devices and/or mechanism for backflow protection may be used.

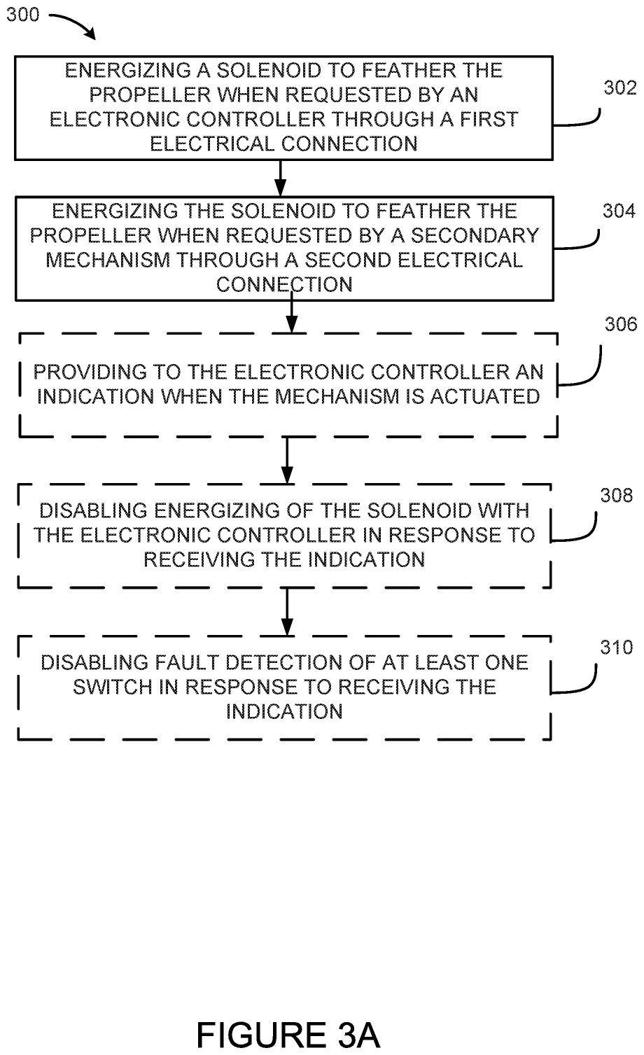

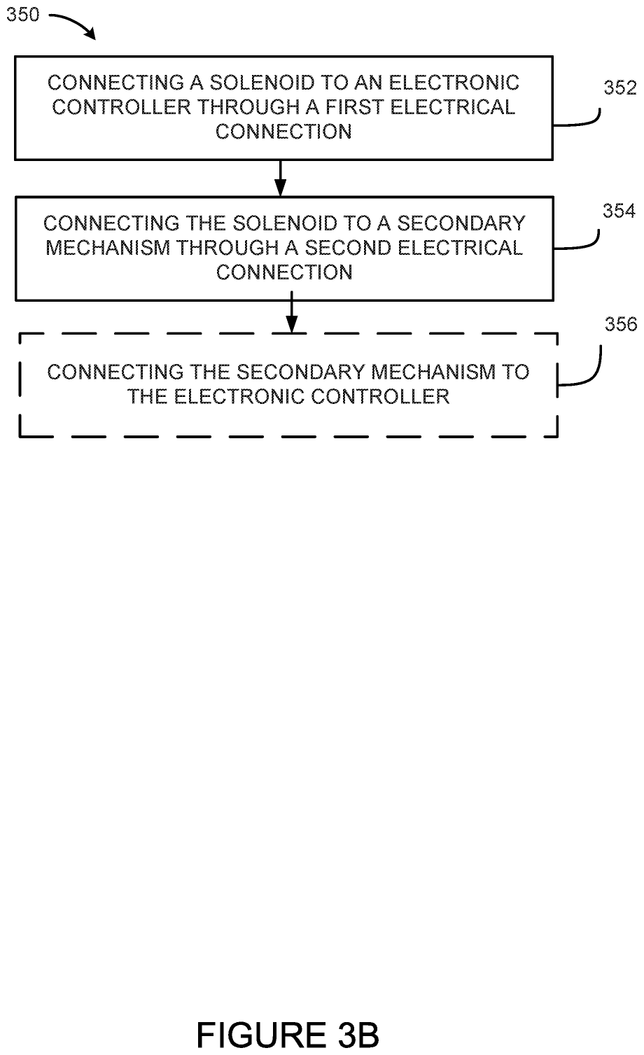

With reference to FIG. 3A there is illustrated a flowchart of a method 300 for feathering a propeller, such as the propeller 120. At step 302, a solenoid 210 is energized to feather the propeller 120 when a first request to energize the solenoid is received from an electronic controller 220 through a first electrical connection 201 with the solenoid 210. At step 304, the solenoid 210 is energized to feather the propeller 120 when a second request to energize the solenoid is received from a secondary mechanism 230 through a second electrical connection 202 with the solenoid 210. The electronic controller 220 and the secondary mechanism 230 are independently operable of each other for energizing the solenoid 210. The second electrical connection 202 is independent from the first electrical connection 201. In some embodiments, the solenoid 210 comprises two coils and energizing the solenoid 210 through the second electrical connection 202 at step 304 comprises energizing one of the two coils through the second electrical connection 202. In some embodiments, at step 306, the method 300 comprises providing to the electronic controller 220 an indication when the secondary mechanism 230 is actuated. The indication is provided from the secondary mechanism 230 and may be provided via an aircraft computer (e.g., aircraft computer 240, 241 and/or 242). In some embodiments, the electronic controller 220 comprises two channels A, B and the indication is provided to each one of the two channels A, B. In some embodiments, at step 308, the method 300 comprises the electronic controller 220 disabling energizing of the solenoid 210 with the electronic controller 220 in response to receiving the indication. In some embodiments, at step 310, the method 300 comprises the electronic controller 220 disabling fault detection of at least one switch used to energize the solenoid 210 through the first electrical connection 201 in response to receiving the indication.

With reference to FIG. 3B there is illustrated a flowchart of a method 350. At step 352, a solenoid 210 is connected to an electronic controller 220 through a first electrical connection 201. The solenoid 210 is configured to cause a propeller 120 to feather when the solenoid 210 is energized by the electronic controller 220 through the first electrical connection 201. At step 352, the solenoid 210 is connected to a secondary mechanism 230 through a second electrical connection 202. The solenoid 210 is configured to cause the propeller 120 to feather when the solenoid 210 is energized by the secondary mechanism 230 through the second electrical connection 202. The second electrical connection 202 is independent from the first electrical connection 201. In some embodiments, at step 354, the secondary mechanism 230 is connected to the electronic controller 220 through a third connection 203. The third connection 203 may be used to provide an indication when the secondary mechanism 230 is actuated. In some embodiments, the secondary mechanism 230 is connected to the electronic controller 220 through at least one aircraft computer 240, 241 and/or 242. In some embodiments, the solenoid 210 comprises two coils 211, 212, and connecting the solenoid 210 to the secondary mechanism 230 comprises connecting one of the two coils 211, 212 to the secondary mechanism 230 via the second electrical connection 202. In some embodiments, the solenoid 210 comprises two coils 211, 212, and connecting the solenoid 210 to the electronic controller 220 comprises connecting one (e.g., first coil 211) of the two coils 211, 212 to a first channel A of the electronic controller 220 and the other one (e.g., second coil 212) of the two coils 211, 212 to a second channel B of the electronic controller 220.

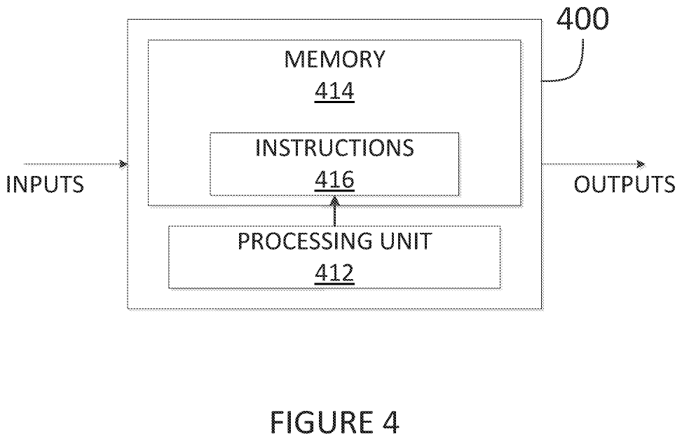

With reference to FIG. 4, an example of a computing device 400 is illustrated. The electronic controller 210 may be implemented with one or more computing devices 400. In some embodiments, each channel A, B of the electronic controller 210 may be implemented by a separate computing device 400. The computing device 400 comprises a processing unit 412 and a memory 414 which has stored therein computer-executable instructions 416. The processing unit 412 may comprise any suitable devices configured to implement the method 300 and/or 350 such that instructions 416, when executed by the computing device 400 or other programmable apparatus, may cause the functions/acts/steps performed as part of the method 300 and/or 350 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412. Note that the computing device 400 can be implemented as part of a full-authority digital engine controls (FADEC) or other similar device, including electronic engine control (EEC), engine control unit (EUC), electronic propeller control, propeller control unit, and the like.

The methods and systems for feathering a propeller described herein may be implemented in a high level procedural or object oriented programming or scripting language, or a combination thereof, to communicate with or assist in the operation of a computer system, for example the computing device 400. Alternatively, the methods and systems for feathering a propeller may be implemented in assembly or machine language. The language may be a compiled or interpreted language. Program code for implementing the methods and systems for feathering a propeller may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for feathering a propeller may also be considered to be implemented by way of a non-transitory computer-readable storage medium having a computer program stored thereon. The computer program may comprise computer-readable instructions which cause a computer, or more specifically the processing unit 412 of the computing device 400, to operate in a specific and predefined manner to perform the functions described herein, for example those described in the method 300 and/or 350.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for feathering a propeller may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A system comprising:
a solenoid configured to cause a propeller to feather when the solenoid is energized;
an electronic controller connected to the solenoid through a first electrical connection for energizing the solenoid to feather the propeller; and
a secondary mechanism connected to the solenoid through a second electrical connection for energizing the solenoid to feather the propeller, the second electrical connection being independent from the first electrical connection.

2. The system of claim 1, wherein the secondary mechanism is connected to the electronic controller and configured to provide to the electronic controller an indication when the secondary mechanism is actuated.

3. The system of claim 2, wherein the electronic controller is configured to disable energizing of the solenoid with the electronic controller in response to receiving the indication.

4. The system of claim 2, wherein the electronic controller is configured to disable fault detection of at least one switch used to energize the solenoid through the first electrical connection in response to receiving the indication.

5. The system of claim 2, wherein the secondary mechanism is connected to the electronic controller via an aircraft computer.

6. The system of claim 2, wherein the electronic controller comprises two channels, and the secondary mechanism is connected to each one of the two channels to provide the indication thereto.

7. The system of claim 1, wherein the solenoid comprises two coils, and the second electrical connection connects the secondary mechanism to one of the two coils.

8. The system of claim 1, wherein the secondary mechanism is configured to close a high side switch and a low side switch when actuated, the solenoid being energized when both the high side switch and the low side switch are closed.

9. The system of claim 1, wherein the secondary mechanism comprises a mechanical lever operable to close at least one switch to energize the solenoid.

10. The system of claim 1, wherein the electronic controller is a first electronic controller, and wherein the secondary mechanism comprises a second electronic controller operable to close at least one switch to energize the solenoid when a push-button connected to the second electronic controller is actuated.

11. A method of feathering a propeller, the method comprising:
energizing a solenoid to feather the propeller when a first request to energize the solenoid is received from an electronic controller through a first electrical connection with the solenoid; and
energizing the solenoid to feather the propeller when a second request to energize the solenoid is received from a secondary mechanism through a second electrical connection with the solenoid, the second electrical connection being independent from the first electrical connection.

12. The method of claim 11, further comprising providing to the electronic controller an indication when the secondary mechanism is actuated.

13. The method of claim 12, further comprising disabling energizing of the solenoid with the electronic controller in response to the electronic controller receiving the indication.

14. The method of claim 12, further comprising disabling fault detection of at least one switch used to energize the solenoid through the first electrical connection in response to the electronic controller receiving the indication.

15. The method of claim 12, wherein providing the indication comprises providing the indication via an aircraft computer.

16. The method of claim 12, wherein the electronic controller comprises two channels, and wherein providing the indication comprises providing the indication to each one of the two channels.

17. The method of claim 11, wherein the solenoid comprises two coils, and wherein energizing the solenoid through the second electrical connection comprises energizing one of the two coils through the second electrical connection.

18. A method comprising:
connecting a solenoid to an electronic controller through a first electrical connection, the solenoid being configured to cause a propeller to feather when the solenoid is energized by the electronic controller through the first electrical connection; and
connecting the solenoid to a secondary mechanism through a second electrical connection, the solenoid being configured to cause the propeller to feather when the solenoid is energized by the secondary mechanism through the second electrical connection, the second electrical connection being independent from the first electrical connection.

19. The method of claim 18, further comprising connecting the secondary mechanism to the electronic controller through a third connection via at least one aircraft computer.

20. The method of claim 18, wherein the solenoid comprises two coils, and wherein connecting the solenoid to the secondary mechanism comprises connecting one of the two coils to the secondary mechanism.
